(19) United States
(12) Patent Application Publication
(10) Pub. No.: US 2009/0327350 A1
(43) Pub. Date: Dec. 31, 2009

(54) INTERACTIVE REVIEW SYSTEM AND METHOD

(76) Inventors: Michael Callahan, Marblehead, MA (US); Marc N. Teal, Dracut, MA (US); Brian Madden, Plymouth, MA (US)

Correspondence Address: HOLLAND & KNIGHT LLP, 10 ST. JAMES AVENUE, BOSTON, MA, 02116-3889, US

(21) Appl. No.: 12/488,041

(22) Filed: Jun. 19, 2009

Related U.S. Application Data
(60) Provisional application No. 61/073,969, filed on Jun. 19, 2008.
(60) Provisional application No. 61/073,960, filed on Jun. 19, 2008.
(60) Provisional application No. 61/073,957, filed on Jun. 19, 2008.

(51) Int. Cl. G06F 17/30; G06F 3/048

(52) U.S. Cl. 707/104.1; 715/780; 707/3; 707/E17.009; 707/E17.014

(57) ABSTRACT

A system, computer-implemented method, and a computer program product for defining rental property data associated with one or more rental properties within a review datastore. One or more user-definable rules are applied to the rental property data to generate suspect data. At least a portion of an interactive review form is populated with at least a portion of the suspect data. A user is enabled to provide user input associated with the suspect data via one or more data-entry fields included within the interactive review form. The user input is stored within the review datastore.

### RELATED APPLICATION(S)

This application claims the benefit of the following provisional patent applications, each of which is herein incorporated by reference in their entirety: U.S. Ser. No. 61/073,969, filed on 19 Jun. 2008; U.S. Ser. No. 61/073,960, filed on 19 Jun. 2008; and U.S. Ser. No. 61/073,957, filed on 19 Jun. 2008.

### TECHNICAL FIELD

This disclosure relates to interactive review of data and, more particularly, to interactive review of rental property data.

### BACKGROUND

Databases are often utilized in enterprise environments to store and organize data. An example of such a database is a database that defines rental property data. Review systems are often utilized with such databases to allow the user to interpret the data stored within the database.

Oftentimes, the type of reviews that are available to the user may be limited to simple summaries of portions of the rental property data. One reason for such a limited summary of rental property data may be due to a lack of interaction with the user, and more specifically, a lack of utilizing data from the user.

### SUMMARY OF DISCLOSURE

In a first implementation, an interactive review system includes a review datastore configured to define rental property data associated with one or more rental properties. A rules engine applies one or more user-definable rules to the rental property data to generate suspect data. An interactive review generation process is configured to populate at least a portion of an interactive review form with at least a portion of the suspect data. The interactive review form includes one or more data-entry fields configured to enable a user to provide user input associated with the suspect data. A storage process is configured to store the user input within the review datastore.

One or more of the following features may be included. The review datastore may be a rental property database. The rental property data may include audit data. The user-definable rules may include one or more thresholds configured to define whether at least a portion of the audit data may be suspect data. The one or more thresholds may represent industry standard thresholds. The one or more thresholds may represent thresholds defined by the user. The one or more data-entry fields may include one or more of: a check box, multiple-choice boxes, and a text field. A rule definition process may allow the user to define the one or more user-definable rules.

In another implementation, a computer-implemented method includes defining rental property data associated with one or more rental properties within a review datastore. One or more user-definable rules are applied to the rental property data to generate suspect data. At least a portion of an interactive review form is populated with at least a portion of the suspect data. A user is enabled to provide user input associated with the suspect data via one or more data-entry fields included within the interactive review form. The user input is stored within the review datastore.

One or more of the following features may be included. The review datastore may be a rental property database. The rental property data may include audit data. The user-definable rules may include one or more thresholds configured to define whether at least a portion of the audit data may be suspect data. The one or more thresholds may represent industry standard thresholds. The one or more thresholds may represent thresholds defined by the user. The one or more data-entry fields may include one or more of: a check box, multiple-choice boxes, and a text field. A rule definition process may allow the user to define the one or more user-definable rules.

In yet another implementation, a computer program product resides on a computer readable medium that has a plurality of instructions stored on it. When executed by a processor, the plurality of instructions cause the processor to perform operations including defining rental property data associated with one or more rental properties within a review datastore. One or more user-definable rules are applied to the rental property data to generate suspect data. At least a portion of an interactive review form is populated with at least a portion of the suspect data A user is enabled to provide user input associated with the suspect data via one or more data-entry fields included within the interactive review form. The user input is stored within the review datastore.

One or more of the following features may be included. The review datastore may be a rental property database. The rental property data may include audit data. The user-definable rules may include one or more thresholds configured to define whether at least a portion of the audit data may be suspect data. The one or more thresholds may represent industry standard thresholds. The one or more thresholds may represent thresholds defined by the user. The one or more data-entry fields may include one or more of: a check box, multiple-choice boxes, and a text field. A rule definition process may allow the user to define the one or more user-definable rules.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an interactive review process coupled to a distributed computing network;

FIG. 2 is a flowchart of the interactive review process of FIG. 1; and

FIG. 3 is a diagrammatic view of an interactive review form of the interactive review process of FIG. 1.

Like reference symbols in the various drawings indicate like elements.

### DETAILED DESCRIPTION OF THE PREFERRED EMBODIMENTS

### System Overview

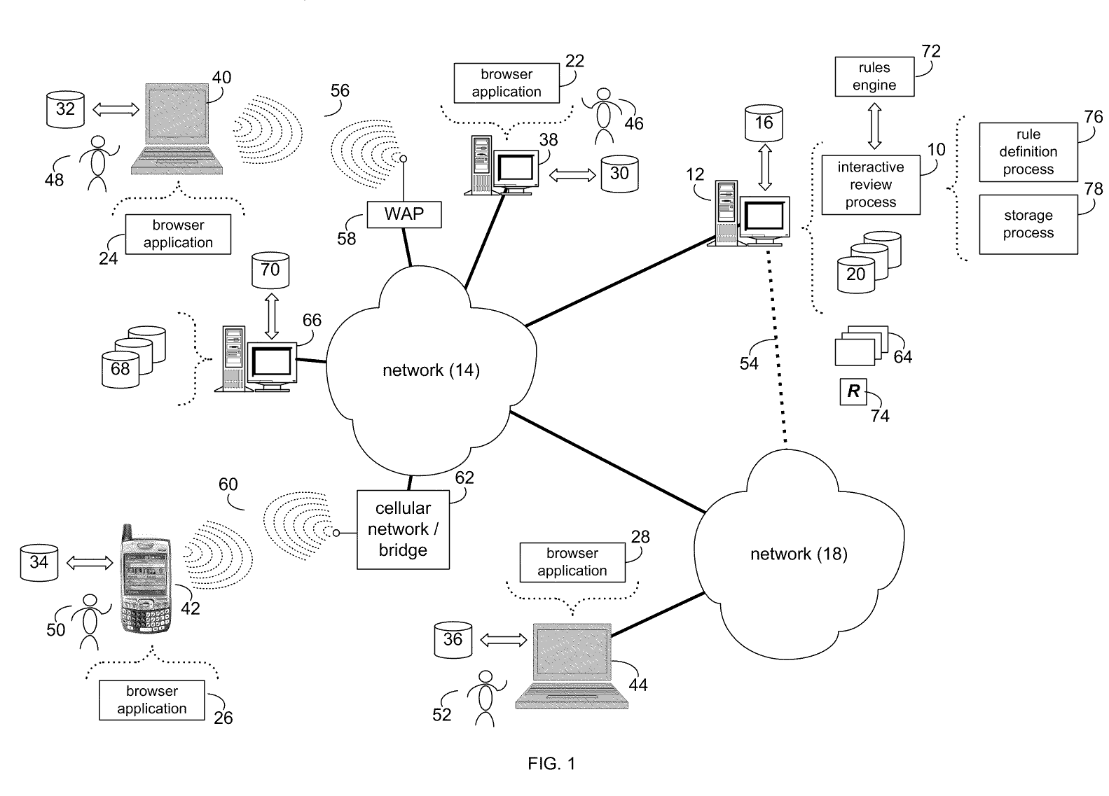

Referring to FIG. 1, there is shown interactive review process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows XP Server™; Novell Netware™; or Redhat Linux™, for example.

As will be discussed below in greater detail, interactive review process 10 may define rental property data associated with one or more rental properties. Interactive review process 10 may include a rules engine that may apply one or more user-definable rules to the rental property data to generate suspect data. Interactive review process 10 may include an interactive review generation process that may be configured to populate at least a portion of an interactive review form with at least a portion of the suspect data. Further, interactive review process 10 may enable a user to provide user input associated with the suspect data, via one or more data entry fields included within the interactive review form. Interactive review process 10 may also include a storage process that may be configured to store the user input within the review datastore.

The instruction sets and subroutines of interactive review process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: IBM WebSphere™, Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute review datastore 20, examples of which may include but are not limited to databases produced by Microsoft and Oracle. Review datastore 20 may allow for an organization to store, manage, and access data stored within the datastore. One non-limiting example of such data may include but is not limited to data concerning rental properties. For example, database records may be generated that identify various rental properties and information concerning such rental properties (e.g., the identity of the owner of the rental property, the purchase price of the rental property, the tax liability of the rental property, and the income generated by the rental property, for example). Review datastore 20 may be a stand-alone application that interfaces with interactive review process 10 or an applet/application that is executed within interactive review process 10.

The instruction sets and subroutines of review datastore 20, which may be stored on storage device 16 coupled to server computer 12, may be executed by one or more processors (not shown) and one or more memory architectures (not shown) incorporated into server computer 12.

One or more client applications (e.g., which may include one or more custom applications, and/or one or more general purpose applications, such as web browsers 22, 24, 26, 28) may access and/or interact with interactive review process 10 and/or review data store 20. The instruction sets and subroutines of browser applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a server (not shown), a data-enabled, cellular telephone (not shown), and a dedicated network device (not shown). Using browser applications 22, 24, 26, 28, users 46, 48, 50, 52 (respectively) may access interactive review process 10 and may provide user input for storage within review datastore 20.

Users 46, 48, 50, 52 may access interactive review process 10 directly through the device on which the browsing application (e.g., browsing applications 22, 24, 26, 28) is executed, namely client electronic devices 38, 40, 42, 44, for example. Users 46, 48, 50, 52 may access interactive review process 10 directly through network 14 or through secondary network 18. Further, server computer 12 (i.e., the computer that executes interactive review process 10) may be connected to network 14 through secondary network 18, as illustrated with link line 54 (shown in phantom).

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, or a custom operating system.

For the following discussion, browser application 22 is going to be described for illustrative purposes. However, this is not intended to be a limitation of this disclosure, as other browsing applications (e.g., browsing applications 24, 26, 28) may be equally utilized.

Assume for illustrative purposes that interactive review process 10 includes review datastore 20 that defines a plurality of database records that identify various rental properties and information concerning such rental properties (e.g., rental property data 64). Further, assume that server computer 66 may execute backend datastore 68 that may be coupled to interactive review process 10 (e.g., via network 14 and/or network 18). Data may be extracted from backend datastore 68 and used to populate review datastore 20. As stated above, examples of backend datastore 68 may include but are not limited to databases produced by Microsoft and Oracle.

The instruction sets and subroutines of backend datastore 68, which may be stored on storage device 70 coupled to server computer 66, may be executed by one or more processors (not shown) and one or more memory architectures (not shown) incorporated into server computer 66.

While backend datastore 68 is shown to be a single datastore, this is for illustrative purposes only and is not intended to be a limitation of this disclosure, as other configurations are possible. For example, backend datastore 68 may include a plurality of individual datastores, examples of which may include but are not limited to an investor database, and a document management database. Additionally, while server computer 66 is shown to be a single server, this is for illustrative purposes only and is not intended to be a limitation of this disclosure, as other configurations are possible. For example, server computer 66 may include a plurality of individual server computers, examples of which may include but are not limited to an investor server computer, and a document management server computer.

### The Interactive Review Process:

As stated above and as will be discussed below in greater detail, interactive review process 10 may define rental property data associated with one or more rental properties. For example, interactive review process 10 may include, and/or interact with, a review datastore (e.g., review datastore 20) configured to define rental property data associated with one or more rental properties. Additionally, interactive review process 10 may apply one or more user definable rules to the rental property data to generate suspect data. In one embodiment, interactive review process 10 may include, and/or interact with, a rules engine (e.g., rules engine 72) that may apply the one or more user-definable rules to the rental property data to generate suspect data. Further, interactive review process 10 may be configured to populate at least a portion of an interactive review form with at least a portion of the suspect data. One or more data-entry fields may be included within the interactive review form, and interactive review process 10 may be configured to enable a user to provide user input associated with the suspect data (e.g., view the one or more data-entry fields). Interactive review process 10 may include, and/or may interact with, a storage process (e.g., storage process 78) and may be configured to store the user input within the review datastore.

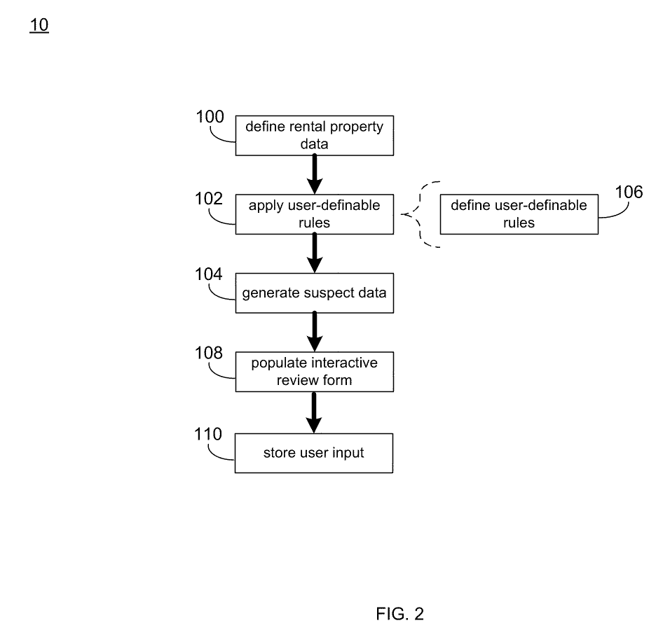

Referring also to FIG. 2, interactive review process 10 may allow a user to define 100 rental property data 64 associated with a plurality of rental properties within review datastore 20. For example, user 46 may directly define 100 rental property data 64 associated with one or more rental properties within reporting datastore 20 via e.g., browser application 22 executed on personal computer 38. Rental property data 64 may include various information associated with one or more rental properties (e.g., the identity of the owner of the rental property, the purchase price of the rental property, the tax liability of the rental property, and the income generated by the rental property, for example). Additionally, rental property data 64 may include audit data associated with one or more rental properties (e.g., financial data relevant to the ownership, operation, and management of the rental properties).

Alternatively, user 46 may directly define 100 rental property data 64 associated with one or more rental properties, for example, within backend datastore 68 via e.g., browser application 22 executed on personal computer 38. At least a portion of rental property data 64 included within backend datastore 68 may be extracted from backend datastore 68 and may be used to populate review datastore 20 (which, as discussed above, may be coupled to backend datastore 68). Accordingly, an independent copy (or a portion thereof) of rental property data 64 included within backend datastore 68 may be maintained within review datastore 20. Therefore, interactive review process 10 need not have access to backend datastore 68 and may only need access to review datastore 20. Further, as at least a portion of rental property data 64 included within backend datastore 68 may be extracted from backend datastore 68 and used to populate review datastore 20, the structure of backend datastore 68 need not be known/understood by user 46, as only the algorithm/process (not shown) used to extract data from backend datastore 68 and populate review datastore 20 needs to know/understand the structure of backend datastore 68.

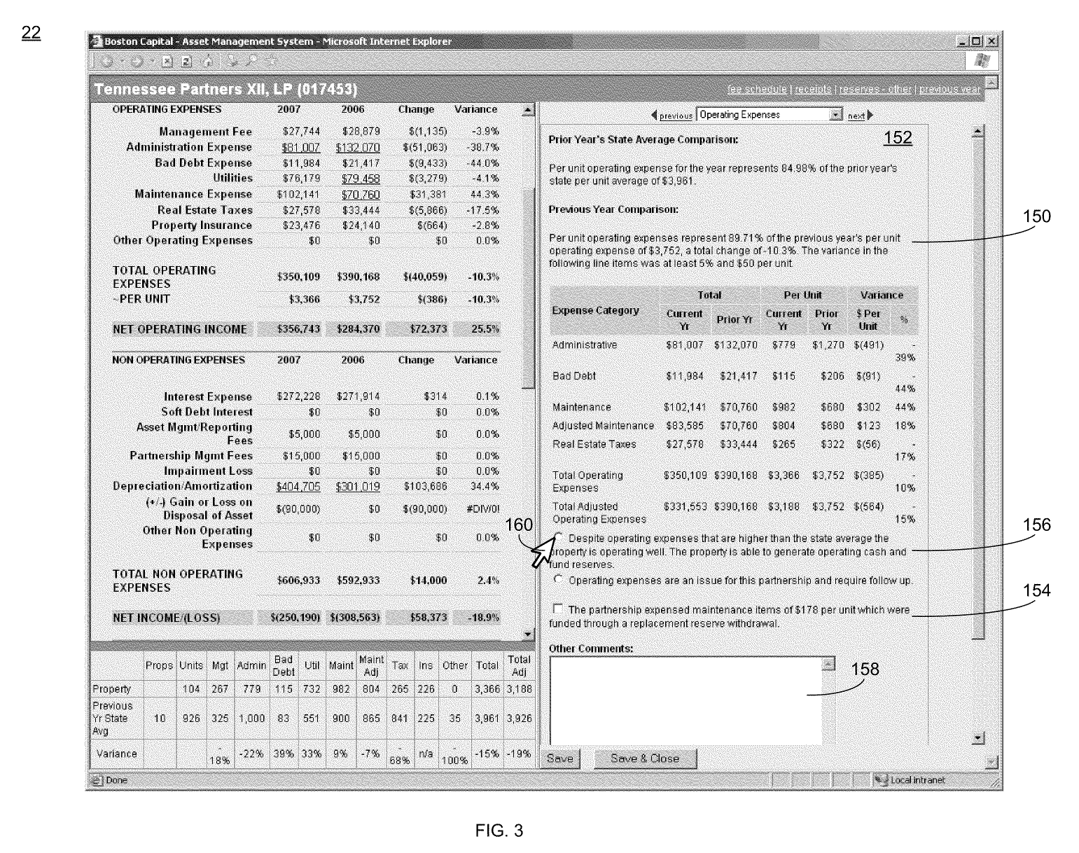

Additionally, and referring also to FIG. 3, interactive review process 10 may include a rules engine (e.g., rules engine 72) that may apply 102 one or more user-definable rules (e.g., user-definable rules 74) to rental property data 64 (e.g., audit data) to generate 104 suspect data (e.g., suspect data 150). As will be discussed in greater detail below, one example of user-definable rules 74 may include, but is not limited to, identifying a change in rental property operating expenses that exceeded, e.g., a 10% threshold. Similarly, one non-limiting example of suspect data 150 may be the identified change in operating expenses that exceed such threshold.

Further, user-definable rules 74 may include one or more thresholds (not shown) configured to define whether at least a portion of the audit data may be suspect data. Additionally/alternatively, interactive review process 10 may include a rule definition process (e.g., rule definition process 76) for allowing the user (e.g., user 46) to define 106 the one or more user-definable rules (e.g., user-definable rules 74).

For example, suppose that user 46 managed many properties and wanted to define 106 a set of rules that performed (among other things) a comparison of audit data (e.g., annual per-unit operating expenses) to identify whether at least a portion of the audit data may be suspect data (e.g., suspect data 150). As shown in FIG. 3, interactive review process 10, alone and/or in conjunction with another application, such as review datastore 20, may provide user 46 with the results of such comparison, including, but not limited to, the identification of suspect data 150 (e.g., audit data regarding a change in rental property operating expenses that exceeded a threshold).

Illustratively, using audit data from, e.g., 2006 and 2007, rules engine 72 may apply 102 a rule (e.g., one of user-definable rules 74) that derives the change in operating expenses from 2006 to 2007. For example, the user-definable rule may filter rental property information defined by review data store 20 for changes from 2006-2007 in operating expensed for one or more of the rental properties. Assuming that the rule included a threshold of, e.g., 10%, rules engine 72 may generate 104 suspect data 150 if the difference exceeded that threshold. That is, rules engine 72 may generate 104 suspect data 150, which may include a listing, summary, etc., of those properties having a change in operating cost greater than 10% between 2006 and 2007.

While user-definable rules 74 have been described above as pertaining to rental property operating expenses, this is not to be construed as a limitation of this disclosure. One of skill in the art will appreciate that any number of other user-definable rules are possible. For example, user-definable rules 74 may also include, but are not limited to: debt-to-equity ratios, occupancy rates, tenant receivables, accounts payable, accrued expenses, management fees, and tax and insurance escrow account balances.

Additionally, the one or more thresholds may represent industry standard thresholds. Examples of industry standard thresholds may include, but are not limited to: debt service coverage ratios, accounts payable as a percentage of monthly expenses, and bad debt as a percentage of net rental income. If the threshold of user-definable rules 74 is set to such an industry standard, rules engine 72 of interactive review process 10 may apply 102 that threshold to rental property data 64 to identify whether the relevant attribute of a particular rental property may be suspect data (e.g., suspect data 150).

Moreover, the one or more thresholds may represent thresholds defined by the user (e.g., user 46, 48, 50, 52). For example, and as described above, user 46 may define 106 a threshold of 10% change in operating expenses to identify whether rental property data 64 (e.g., audit data) may be suspect data (e.g., suspect data 150).

Additionally, interactive review process 10 may be configured to populate 108 at least a portion of an interactive review form (e.g., interactive review form 152) with at least a portion of the suspect data (e.g., suspect data 150). Further, interactive review form 152 may include one or more data-entry fields that may be configured to enable a user (e.g., user 46) to provide user input associated with the suspect data (e.g., suspect data 150). The one or more data-entry fields may include one or more of: a check box (e.g., check box 154), multiple-choice boxes (e.g., multiple-choice box 156), and a text field (e.g., text field 158).

Continuing with the above-stated example, after population 108 of interactive review form 152 with suspect data 150, user 46 may review suspect data 150 and wish to provide feedback (i.e., user input) relevant to suspect data 150. As interactive review process 10 has provided, e.g., multiple-choice box 156 to query user 46 regarding whether the operating expenses require follow-up, user 46 may provide user input by, e.g., utilizing on-screen pointer 160 to select one of the options in multiple-choice box 156.

Additionally, interactive review process 10 may include a storage process (e.g., storage process 78) configured to store 110 the user input within the review datastore (e.g., review datastore 20). For example, after user 46 provided user input utilizing multiple-choice box 156, storage process 78 may store 110 the user input in review datastore 20 for, e.g., further use or review by user 46 or other users (e.g., user 48, 50, 52).

A number of implementations have been described. Nevertheless, it will be understood that various modifications may be made. Accordingly, other implementations are within the scope of the following claims.

What is claimed is:

1. An interactive review system comprising:
a review datastore configured to define rental property data associated with one or more rental properties;
a rules engine for applying one or more user-definable rules to the rental property data to generate suspect data;
an interactive review generation process configured to populate at least a portion of an interactive review form with at least a portion of the suspect data, the interactive review form including one or more data-entry fields configured to enable a user to provide user input associated with the suspect data; and
a storage process configured to store the user input within the review datastore.

2. The interactive review system of claim 1 wherein the review datastore is a rental property database.

3. The interactive review system of claim 1 wherein the rental property data includes audit data.

4. The interactive review system of claim 3 wherein the user-definable rules include one or more thresholds configured to define whether at least a portion of the audit data is suspect data.

5. The interactive review system of claim 4 wherein the one or more thresholds represent industry standard thresholds.

6. The interactive review system of claim 4 wherein the one or more thresholds represent thresholds defined by the user.

7. The interactive review system of claim 1 wherein the one or more data-entry fields include one or more of: a check box, multiple-choice boxes, and a text field.

8. The interactive review system of claim 1 further comprising a rule definition process for allowing the user to define the one or more user-definable rules.

9. A computer-implemented method comprising:
defining rental property data associated with one or more rental properties within a review datastore;
applying one or more user-definable rules to the rental property data to generate suspect data;
populating at least a portion of an interactive review form with at least a portion of the suspect data;
enabling a user to provide user input associated with the suspect data via one or more data-entry fields included within the interactive review form; and
storing the user input within the review datastore.

10. The computer-implemented method of claim 9 wherein the review datastore is a rental property database.

11. The computer-implemented method of claim 9 wherein the rental property data includes audit data.

12. The computer-implemented method of claim 11 wherein the user-definable rules include one or more thresholds configured to define whether at least a portion of the audit data is suspect data.

13. The computer-implemented method of claim 12 wherein the one or more thresholds represent industry standard thresholds.

14. The computer-implemented method of claim 12 wherein the one or more thresholds represent thresholds defined by the user.

15. The computer-implemented method of claim 9 wherein the one or more data-entry fields include one or more of: a check box, multiple-choice boxes, and a text field.

16. The computer-implemented method of claim 9 further comprising a rule definition process for allowing the user to define the one or more user-definable rules.

17. A computer program product residing on a computer readable medium having a plurality of instructions stored thereon, which, when executed by a processor, cause the processor to perform operations comprising:
defining rental property data associated with one or more rental properties within a review datastore;
applying one or more user-definable rules to the rental property data to generate suspect data;
populating at least a portion of an interactive review form with at least a portion of the suspect data;
enabling a user to provide user input associated with the suspect data via one or more data-entry fields included within the interactive review form; and
storing the user input within the review datastore.

18. The computer program product of claim 17 wherein the review datastore is a rental property database.

19. The computer program product of claim 17 wherein the rental property data includes audit data.

20. The computer program product of claim 19 wherein the user-definable rules include one or more thresholds configured to define whether at least a portion of the audit data is suspect data.

21. The computer program product of claim 20 wherein the one or more thresholds represent industry standard thresholds.

22. The computer program product of claim 20 wherein the one or more thresholds represent thresholds defined by the user.

23. The computer program product of claim 17 wherein the one or more data-entry fields include one or more of: a check box, multiple-choice boxes, and a text field.

24. The computer program product of claim 17 further comprising a rule definition process for allowing the user to define the one or more user-definable rules.
